(19) United States
(12) Patent Application Publication
(10) Pub. No.: US 2003/0163558 A1
(43) Pub. Date: Aug. 28, 2003

(54) System and method for Hyper Operator controlled network probing across overlaid heterogeneous access networks

(75) Inventors: Jingjun Cao, Mountain View, CA (US); Fujio Watanabe, San Jose, CA (US); Shoji Kurakake, San Francisco, CA (US)

Correspondence Address: BRINKS HOFER GILSON & LIONE, P.O. BOX 10395, CHICAGO, IL, 60611, US

(73) Assignee: DoCoMo Communications Laboratories USA, Inc.

(21) Appl. No.: 10/082,640

(22) Filed: Feb. 25, 2002

(51) Int. Cl. G06F 15/173

(52) U.S. Cl. 709/223

(57) ABSTRACT

A method and system are disclosed for an operator to monitor access network services available to an end device, where the end device communicates in a heterogeneous network environment. The heterogeneous access networks can include networks such as a cellular network, a satellite network, a local area network (LAN) and a Bluetooth network. Different access networks may be available to the end device based on a location of the end device and a time that the network is being accessed. A subscriber to the system, or user of the end device, desires access to a particular network depending on the available access networks. To determine which access networks are available, an operator instructs the end device to determine available access networks located with the heterogeneous network environment. The access network information is collected from at least one node within the heterogeneous network, and made available to the operator. Thereafter, the access network can be provided to the end device in accordance with collected information.

### FIELD OF THE INVENTION

The present invention relates generally to network management and more particularly, to methods and systems for heterogeneous access network availability and performance monitoring by network operators.

### BACKGROUND

Wireless telecommunication networks are quickly converging with the Internet. The success of i-mode in Japan demonstrates the trend. Fourth generation cellular networks, which feature all (Internet Protocol) IP enabled network layer and application enabled end devices, are already under development and are projected to be deployed in the upcoming decade. End devices include, for example, cellular phones, personal digital assistants (PDAs) and laptop computers. Future end devices will likely be able to access Internet applications and services the world over.

Additionally, various wireless communication technologies are converging. It is anticipated that future wireless access networks will be heterogeneous, such that a wireless carrier may offer other access networks such as wireless LAN's, in addition to cellular networks. In addition, the wireless carrier may offer satellite networks and Bluetooth networks. A new type of wireless carrier, called a Hyper Operator, may emerge. A problem occurs in that the Hyper Operator may or may not own the different infrastructures of the heterogeneous access networks. But through technology innovations and business alliances, Hyper Operators may be able to offer services across the heterogeneous access networks.

Thus, for a subscriber to the telecommunications networks, there will probably exist an overlay of heterogeneous access networks available to the subscriber at a particular location. The access networks may have different quality of service (QoS) characteristics and different costs. For example, bandwidth, latency and a rate of error could differ between the access networks. And if the subscriber is participating in a teleconference that includes video, for example, the subscriber may be willing to pay a higher price for a type of network access that provides reduced latency.

A problem occurs in that to provide the subscriber with an available access network, the Hyper Operator must determine what access networks are available to the subscriber at a particular location of the subscriber. There currently exists no known way for the Hyper Operator to efficiently and effectively determine what access networks are available. Thus, there is a need for a system and way to determine what networks are available to a subscriber at a particular location of the subscriber.

A similar problem occurs in that the Hyper Operator will need to monitor and compare the qualities of service of the available access network connections available to each single user at a given location, in order to manage the service level agreement associated with the subscribers. For example, one subscriber may pay a premium subscription fee and require the best available connectivity, so the Hyper Operator needs to handoff the subscriber to a wireless LAN that has better connectivity services from a cellular network data connection as soon as the subscriber enters the wireless LAN coverage area. There currently exists no known systematic network management technologies for the Hyper Operator to dynamically monitor and compare available access network connection qualities.

### BRIEF SUMMARY

A system and method are disclosed to provide an access network to an end device that communicates in an environment of overlaid heterogeneous access networks. The heterogeneous access networks can include networks such as a cellular network, a satellite network, a local area network (LAN) and a Bluetooth network. A Hyper Operator, or other access network provider, determines various access networks available to an end device of a subscriber for a particular time and for a location of the subscriber.

The determination can be used to select an available access network for the subscriber. Selection of the available access networks can be based on different factors, for example, the subscriber's contract policy. The subscriber's contract policy can specify a desired quality of service, such as, a wireless link error rate, transmission latency, or IP route efficiency to a remote correspondent node. The results of the determined available access networks can also be used to perform a hyper handover, i.e., a substantially seamless handoff between two types of different access networks, such as from a cellular network to a wireless LAN.

To determine which access networks are available, an operator instructs the end device to determine available access networks located with the heterogeneous network environment. The access network information is collected from at least one node within the heterogeneous network, and sent to the operator. Thereafter, the access network can be provided to the end device in accordance with collected information.

### BRIEF DESCRIPTION OF THE DRAWINGS

FIG. 1 is a block diagram illustrating a multiple network interface according to a preferred embodiment.

FIG. 2 is a block diagram illustrating a multiple network interface including a probing server according to a preferred embodiment.

FIG. 3 is a block diagram illustrating components of the probing server of FIG. 2 according to a preferred embodiment.

FIG. 4 is a block diagram illustrating a probing component of an end device according to a preferred embodiment.

FIG. 5 is a block diagram of an embodiment of an end device network-monitoring module according to a preferred embodiment.

FIG. 6 is a block diagram illustrating a format of an embodiment of a tracer packet generated by a network-monitoring module depicted in FIG. 4.

FIG. 7 is a block diagram illustrating the probing server communication control according to a preferred embodiment.

FIG. 8 is a block diagram illustrating the probing server of FIG. 3 including an exemplary message sequence according to a preferred embodiment.

FIG. 9 is a block diagram illustrating the probing component of FIG. 4 including an exemplary message sequence according to a preferred embodiment.

FIG. 10 is a block diagram illustrating the probing component of FIG. 4 including an exemplary message sequence with real-time probing according to a preferred embodiment.

### DETAILED DESCRIPTION

According to a preferred embodiment, a Hyper Operator, or other operator or access network provider, determines various access networks available to an end device of a subscriber for a particular time and for a location of the subscriber. The determination can be used to select an available access network for the subscriber based on, for example, the subscriber's contract policy. The results can also be used to perform hyper handovers, i.e., a substantially seamless handoff between two types of different access networks, such as from a cellular network to a wireless LAN.

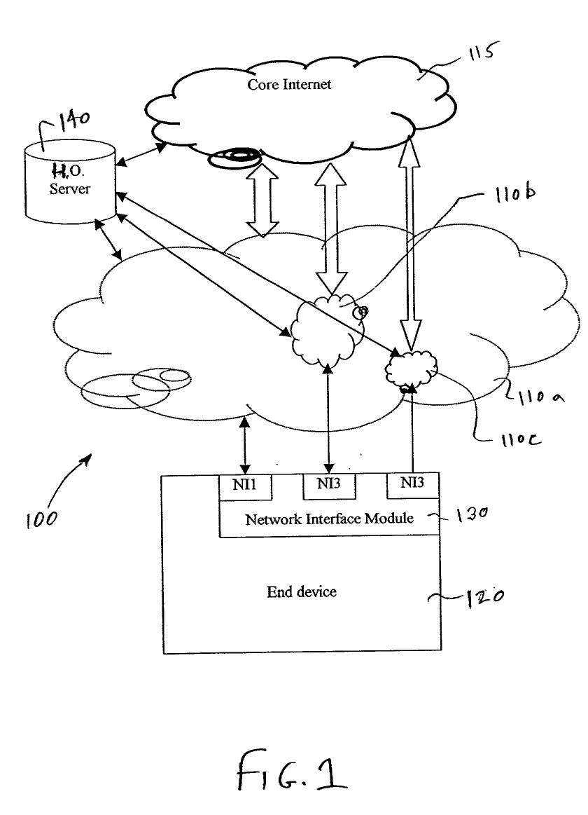

FIG. 1 illustrates a communications system 100. The system 100 includes one or more access networks 110a-c. The access networks 110a-c can include networks such as a cellular network, a satellite network, a local area network (LAN) and a Bluetooth network. A subscriber to the system 100 uses the access networks 110a-c to communicate with a network, such as core Internet 115, using an end device 120. Typical end devices 120 include a desktop computer, a laptop computer, a smart phone, such as a cellular phone with data application capabilities, and a personal digital assistant (PDA) or other wireless mobile devices utilized by the subscriber to interface with the communications system 100. Other end devices 120 may also include monitoring devices that monitor video, chemical and/or a location. The end device 120 may be any device acting as a source of data packets and a destination for data packets transmitted in a datastream over the communications system 100.

As used herein, the terms “packets,” “data packets” or “datagrams” refers to transmission protocol information as well as data, video, audio or any other form of information that may be transmitted over the communications system 100. The term subscriber represents an operator of the end device 120. The end device 120 may include a user interface (UI) such as, for example, a graphical user interface (GUI), buttons, voice recognition, touch screens or any other mechanism allowing interaction between the subscriber and the end device 120. In addition, the end device 120 may include a processor, memory, a data storage mechanism and any other hardware to launch and run applications.

Applications may include software, firmware or some other form of computer code. In the presently preferred embodiments, the end device 120 includes an operating system and applications capable of communicating with remote applications operating elsewhere in the communications system 100. For example, an end user may activate an end device 120 such as a wireless phone. When the wireless phone is activated, an application is launched to provide the functions available from the wireless phone such as dialing and receiving phones calls. In addition, the user may initiate other applications to communicate with remote application services located elsewhere in the communications system 100, such as, for example, instant messaging, an Internet browser, email services, stock market information services, music services, video on demand services and the like. Packets transmitted and received by the end device 120 over the communications system 100 may travel through the access networks 110a-c and to the core Internet 115.

To connect to the access networks 110a-c, the end device 120 of the subscriber preferably includes a network interface module 130. The network interface module 130 includes one or more network interfaces, for example, NI1, NI2 and NI3. The network interfaces NI1, NI2 and NI3 connect the end device 120 to one or more access networks 110a-c. The access networks 110a-c connect the end device 120 to the core Internet 115. Particular access networks 110a-c that are available to the end device 120 may depend on a time of access and/or a location of the end device 120. A Hyper Operator uses a Hyper Operator server 140 to monitor network availability and performance condition, such as the access networks 110a-c and the core Internet 115.

The communications system 100 of the presently preferred embodiment includes a packet-switched communication network. An exemplary communication protocol for the communications system 100 includes the Transport Control Protocol/Internet Protocol (“TCP/IP”) network protocol suite, however, other Internet Protocol based networks, proprietary protocols, or any other form of network protocols are possible. Communications may also include, for example, IP tunneling protocols such as those that allow virtual private networks coupling multiple intranets or extranets together via the Internet. The communications system 100 may support protocols, such as, for example, Telnet, POP3, Multipurpose Internet mail extension (MIME), secure HTTP (S-HTTP), point-to-point protocol (PPP), simple mail transfer protocol (SMTP), proprietary protocols, or any other network protocols known in the art.

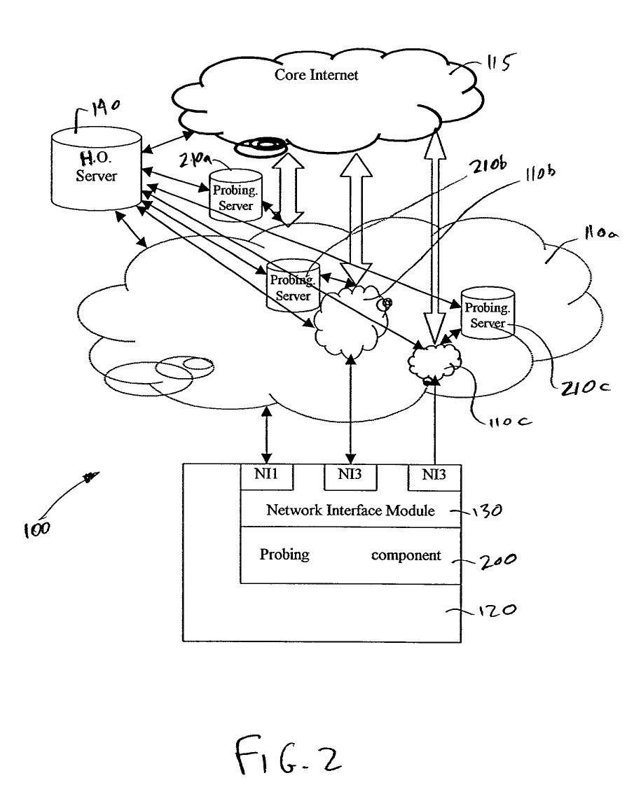

FIG. 2 illustrates the communication system 100 with the addition of a probing component 200 and one or more probing servers 210a-c. The Hyper Operator or other operator uses the probing server 210a-c to control the end device 120 to search for available access networks 110a-c and probe for quality of service information of available access networks 110a-c. The probing server 210a-c also stores information about access measures available to the end device 120 and other information about the end device, such as the terms of the service contract with the subscriber of the end device 120. The probing servers 210a-c also maintains data about end devices 120, such as how to communicate with the end device. The data can be stored in a database located with the probing server 210a-c or located away from the probing server 210a-c but accessible to it.

As described herein, the probing component 200 and the probing server 210a-c are used to help determine which access networks 110a-c with what quality of services are available to an end device 120, for a particular time and at a particular location of the subscriber. The probing component 200 preferably resides with the end device 120. The probing servers 210a-c preferably reside on gateways connected between the access networks 110a-c and the core Internet 115. There could be one or more probing servers 110a-c in the communication system 100. Preferably there is at least one probing server for each access network gateway.

Heterogeneous access network 110a-c infrastructures can provide integrated access services to the subscriber. The Hyper Operator provides integrated network access services through business contracts and technology innovation across the heterogeneous access networks 110a-c. For example, a contract may state that the subscriber is to always receive the access network with the greatest bandwidth available to the end device 120. The end devices 120 can be located within coverage of an overlay of different access networks 110a-c. The Hyper Operator, whom the subscriber subscribes to, may or may not own all the access network infrastructures, but may, through contracts with other network operators, be able to provide the access networks to the subscriber.

The Hyper Operator accesses the probing servers 210a-c to determine which access networks 110a-c are available for a particular time and location of the end device 120. The Hyper Operator also accesses the probing servers 210a-c to determine the related quality of service available at the end device 120. The probing server 210a-c instructs the end devices 120 to determine the available access networks 110a-c and quality of service available. The probing server 210a-c can initiate such probes either continuously or periodically, for example, depending on the contract of the subscriber. For example, if the subscriber has a contract to always be provided with the access network 110a-c having the greatest bandwidth, then the probing server may instruct the end device 120 to probe more often than if the contract merely specified that the end device be connected with any available access network 110a-c. Similarly, the probing server 210a-c can instruct the end device 120 to probe based on an event, for example when the bandwidth available to the end device 120 falls below a certain percentage of a determined bandwidth.

The probing servers 210a-c connect to the Hyper Operator server 140 so that the Hyper Operator can access the probing servers 210a-c. For example, the Hyper Operator can provide new contract information to the probing server 210a-c so that the probing server can adjust the conditions under which the end device 120 should probe. The probing servers 210a-c can preferably manage concurrent sessions of end device initiated probing (described below).

The probing component 200 and probing servers 210 can be implemented with software, hardware, firmware or a combination thereof. The probing component 200 located on the end device 120 interacts with one or more probing servers 210a-c to determine available access networks 110a-c. The probing servers 210a-c communicate with the probing system of the end device using known ways to communicate, such as by using Internet protocol (IP) packets or the other packets described above. The probing server 210a-c coordinates and controls the end device 120 to probe the available access networks 110a-c and the quality of service of the available access networks. While specific ways to probe are beyond the scope described here, one type of probing is described in commonly assigned patent application to Cao et al. entitled “SYSTEM FOR END USER MONITORING OF APPLICATIONS AND NETWORK SERVICE CONDITIONS ACROSS HETEROGENEOUS NETWORKS,” (attorney docket number 10745/40), which is incorporated by reference herein. Alternatively, the end devices 120 can probe for available access networks 210a-c by querying all the base stations or other intermediate nodes in the access network within the range of the end device.

The probing servers 210a-c send control commands to the end device 120 through a default network connection, such as network connection NI1, of the end device 120. The probing component 200 located on the end device 120 receives commands from the probing servers 210a-c. In response to the commands, the probing component 200 performs probing services and reports the probing results to the requesting probing server 210a-c. In this manner, the probing component 200 can operate automatically, without the subscriber's intervention. Alternatively, the subscriber and/or the end device 120 can initiate the probing action.

The results of the probing can be stored in local cache memory of the end device 120. The Hyper Operator can access the local memory of the end device 120 via the probing server 140 by using the default network connection. Alternatively, the probing servers 210a-c can also store recent probing data of end devices 120 in cache memory located on the probing servers. By determining available access networks 110a-c in this manner, the load of access network condition monitoring is distributed to individual end devices 120 and the access networks 110a-c, and away from the Hyper Operator. The described system can be scalable and efficient because probing is done when and where it is needed, yet the logical control of the probing is centralized.

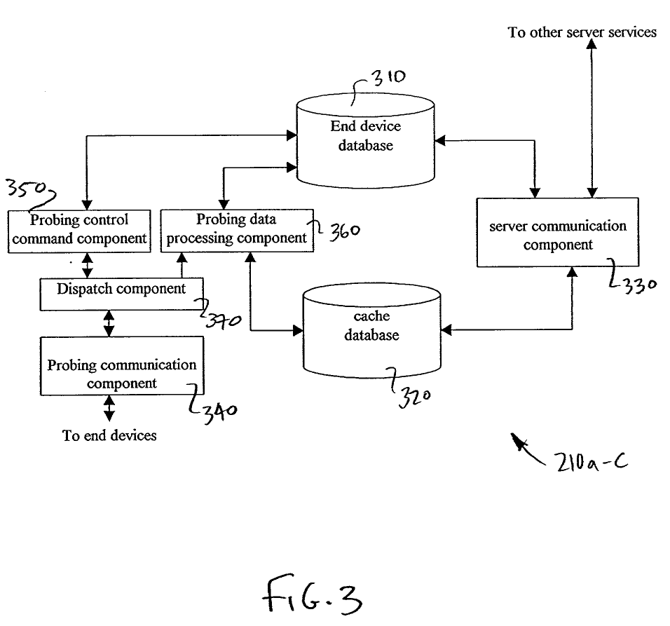

FIG. 3 illustrates some of the software and other components of the probing server 210a-c, which accommodate the determination of access networks 110a-c available to the end device 120. The probing server 210a-c includes an end device database 310, which contains information about the end devices 120. The information includes, for example, how to communicate with the end device 120. The probing server 210a-c also includes a cache database 320, which stores the probing result information for each end device 120 for a short term, for example, a few days. The cache database 320 can also store the probing result information for longer or shorter time periods. A server communication component 330 connects to the end device database 310 and the cache database 320 to handle the interaction between the probing server and other servers such as the Hyper Operator server 140.

The probing server 210a-c also includes a probing communication component 340 to accommodate the sending and receiving of probing control information and data traffic to and from the end devices 120. A probing control command component 350 determines when and what to probe, based on an event, for example, a signal form the Hyper Operator server 140 or automatically, for example, within a periodic or non-periodic time frame. A probing data processing component 360 receives probing result data from the end device 120, preliminarily processes the data, and stores the data into the cache database component 320. A dispatch component 370 connects the probing communication component 340 with the probing control command component 350 and probing data processing component 360. The dispatch component 370 handles the multiplexing of control and data traffic from the end device 120 to/from the probing control command component 350 and probing data processing component 360.

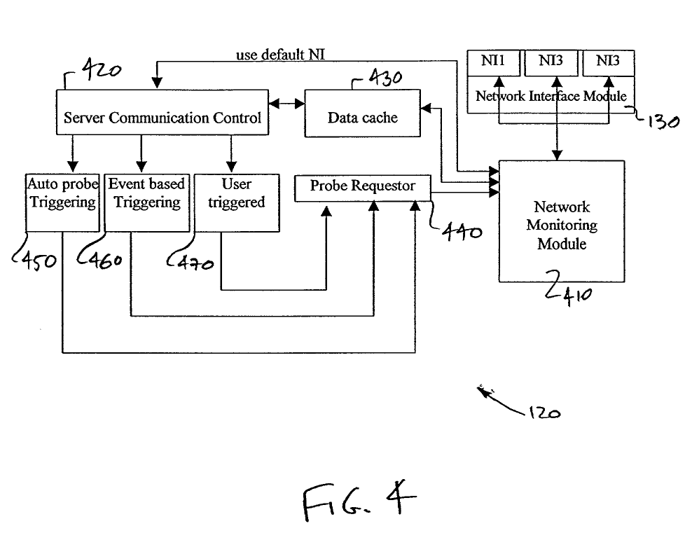

FIG. 4 illustrates components of the end device 120. The end device 120 includes a Network Monitoring Module (NMM) 410. The end device NMM 410 may generate probes to determine access network 210a-c available to the end device 120. One type of probe is to use a tracer packet described in the commonly assigned patent application to Cao et al. entitled “SYSTEM FOR END USER MONITORING OF APPLICATIONS AND NETWORK SERVICE CONDITIONS ACROSS HETEROGENEOUS NETWORKS.” The probing of network operating conditions may be performed from the end device 120 using one or more tracer packets or other ways, such as specific queries to the base stations or other intermediate nodes in the access networks. While other ways to probe may be used, the preferred embodiments will be described in terms of tracer packets. The tracer packets may be selectively inserted into the datastream with other packets sent over the heterogeneous access networks 110a-c. The tracer packets may perform network service probing to collect information about the access networks 110a-c before returning to the end device 120. In general, network service probing provides information related to which access networks 110a-c are available to the subscriber of the end device 120 for the subscriber's location. The end device NMM 410 may extract the information from the tracer packets. The information can then be made available to the Hyper Operator.

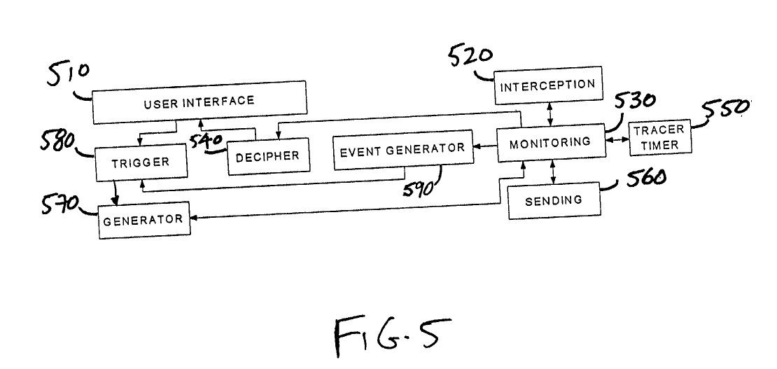

FIG. 5 is a block diagram illustrating components of one embodiment of the end device NMM 410 operating on the end device 120 (FIG. 1). The end device NMM 410 includes a User Interface component (UIC) 510, an end device packet Interception component (IC) 520, a traffic Monitoring component (MC) 530, a packet Decipher component (DC) 540, a Tracer Timer component (TTC) 550, a packet Sending component (SC) 560, a packet Generator component (GC) 570, a probing Trigger component (TC) 580 and an Event Generator component (EGC) 590. In other embodiments, additional or fewer components may be identified to describe the functionality of the end device NMM 410.

In still other embodiments, a portion of the end device NMM 410 may operate in the end device 120 and another portion of the end device NMM 410 may operate elsewhere in the communication system 100. For example, tracer packets may be generated elsewhere at the direction of the portion of the end device NMM 410 in the end device 120. After traveling through the communication system 100, the tracer packets may return to the portion of the end device NMM 410 operating in the end device 120 for processing.

The User Interface component 510 may cooperatively operate with the user interface of the end device 120 to present the results of network service probing to the user. In addition, the User Interface component 510 may allow a user to direct the operation of the end device NMM 410 via the user interface (UI). Further, settings such as, for example, a probing mode, time out intervals or any other parameters and/or settings related to probing the communication system 100 may be configured utilizing the user interface component 510. The User Interface component 510 can also be accessed by the Hyper Operator, for example, via the Hyper Operator server 140.

The end device packet Interception component 520 may intercept datastream traffic between the access networks 110a-c and applications operating on the end device 120. In the illustrated embodiment, the end device packet Interception component 520 may pass datastreams to the traffic Monitoring component 530.

The traffic Monitoring component 530 may monitor the traffic flow. Monitoring the traffic flow involves keeping track of information such as, for example, application processes within the end device 120 incurring network traffic, realized bandwidth variation and/or any other information related to traffic flow between the end device 120 and the access networks 110a-c. The traffic Monitoring component 530 may monitor for tracer packets in the incoming traffic flow from the access networks 110a-c. Upon recognition of incoming tracer packets, the traffic Monitoring component 530 may pass such tracer packets to the packet Decipher component 540.

The packet Decipher component 540 may extract access network information from the tracer packets, stored by the intermediate nodes in the access networks. In addition, the packet Decipher component 540 may utilize the extracted information to compile the results of the network service probing. The network service probing results may then be forwarded to the User Interface component 510. The User Interface component 510 of one embodiment may display the results in the form of a graph or chart upon a GUI of the end device 120 and/or forward the results to a server of the Hyper Operator, for example, at the Hyper Operator server 140.

In addition to processing incoming datastreams, the traffic Monitoring component 530 may also process outgoing datastreams. Outgoing datastreams may include packets of application data generated by applications operating in the end device 120 as well as tracer packets. The traffic Monitoring component 530 may receive the packets of application data and mix outgoing tracer packets therewith to include in the outgoing datastream. Prior to mixing, the outgoing tracer packets may be registered by the traffic Monitoring component 530 with the Tracer Timer component 550.

The Tracer Timer component 550 may maintain a sending time for each outgoing tracer packet. The frequency with which tracer packets are sent is preferably determined by the probing server 210a-c, but may also be determined by the Hyper Operator server 140 or end device 120. Using the sending times, when a tracer packet sent by the end device 120 is lost, the Tracer Timer component 550 may reach a time out limit and inform the traffic Monitoring component 530. The time out limit of one embodiment is a determined time period. In another embodiment, the time out limit may be dynamically determined based on network conditions, end device 120 operating conditions or any other parameters. Timing by the Tracer Timer component 550 may be suspended by the traffic Monitoring component 530 upon receipt of the incoming tracer packet from the heterogeneous access networks 110a-c.

The outgoing datastream that includes the packets of application data and the tracer packets may be passed by the traffic Monitoring component 530 to the packet Sending component 560. The packet Sending component 560 may inject the outgoing datastream into the heterogeneous access networks 110a-c. The packet Sending component 560 may also receive and forward incoming datastreams to the packet Monitoring component 530. In one embodiment, the packet Sending component 560 may forward the outgoing datastreams to the probing servers 210a-c. In addition, the packet Sending component 560 may receive incoming datastreams from the probing servers 210a-c.

Tracer packets may be generated by the packet Generator component 570. Once enabled, the packet Generator component 570 determines what to probe and generates a tracer packet corresponding thereto. The determination of what to probe involves calling the traffic Monitoring component 530 to identify a destination. The destination may be any device or system within the communications system 100 that network service probing is directed toward, or in/beyond the core Internet 115. For example, in the embodiment illustrated in FIG. 2, the destination may be a probing server 210a-c or the Hyper Operator server 140.

The tracer packets generated by the packet Generator component 570 are specialized packets capable of traveling through the communication system 100 as part of the datastream along with the packets of application data. Accordingly, the tracer packets may follow the same route as other data traffic and do not disrupt the stability of packet transportation through the communication system 100. In addition, tracer packets may be treated similarly to any other packet in the datastream by nodes which do not include a Network Monitoring Module (NMM).

The tracer packets, however, include characteristics allowing identification of the tracer packets. In addition, the tracer packets may be capable of carrying variable amounts of data, a destination address identifying the destination and a source address identifying the end device 120 from which the tracer packet was generated. The destination address and source address may be any form of identifier that may be used within the communication system 100 such as, for example, a Uniform Resource Identifier (URI), a name, a number or any other form of unique nomenclature. In the presently preferred embodiments, the destination address and source address are a destination IP address and a source IP address, respectively. The ability to carry variable amounts of data advantageously provides the flexibility to modify the format and/or the content of the tracer packets.

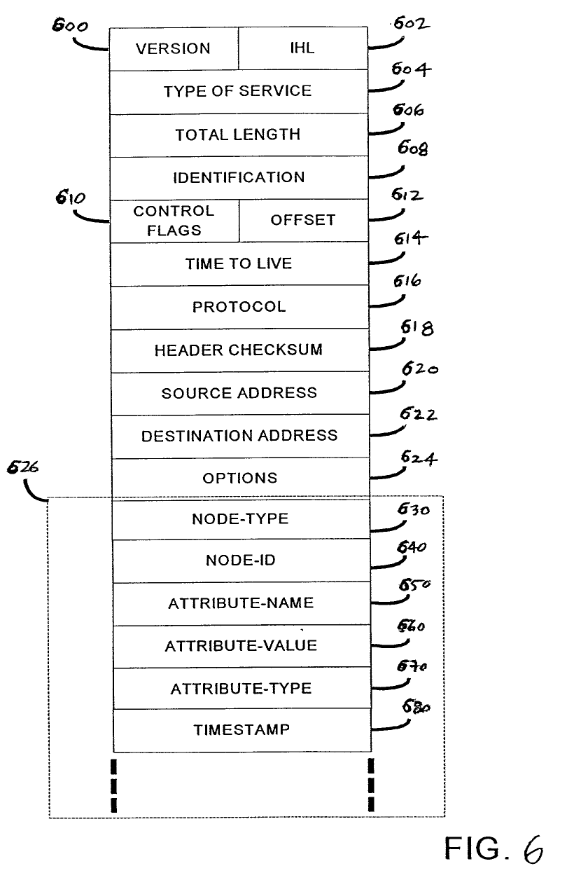

FIG. 6 is block diagram illustrating a format of an embodiment of a tracer packet. The tracer packet uses the Internet header format of a known IP packet as defined by the Internet Protocol DARPA Internet Program Protocol Specification RFC 791 (September 1981). The illustrated tracer packet includes a version field 600, an Internet header length (IHL) field 602, a type of service field 604, a total length field 606, an identification field 608, a control flags field 610, an offset field 612 and a time to live field 614. In addition, the tracer packet includes a protocol field 616, a header checksum field 618, a source address field 620, a destination address field 622, an options field 624 and Heterogeneous Access Network Tracking (HANT) data 626.

Many of the illustrated fields of the tracer packet of this embodiment are populated with data similar in functionality to an application data IP packet. Accordingly, nodes that do not include an NMM 410 may treat the tracer packet as a regular data IP packet. For example, the source address field 620 of tracer packets may be an IP address of the end device 120. In addition, the destination address field 622 may be, for example, an IP address of the probing server 210a-c. Accordingly, awareness of the structure and/or topology of the access networks 110a-c, as well as the rest of the network architecture, by the end device NMM 410 is unnecessary. Thus, implementation of the end device NMM 410 on the end device 120 may be straightforward. For purposes of brevity, the remainder of this discussion will focus on those aspects of the data contained in the tracer packets that is dissimilar in functionality from the functionality of data in typical application data IP packets.

The protocol field 616 of the tracer packet may be populated with a predetermined protocol value. As known in the art, assignments for existing IP protocol values, such as, for example, “6” for TCP, “1” for ICMP and “17” for UDP are described in the Assigned Numbers Specification-Network Working Group RFC 1700 (October 1994). The protocol value for the tracer packet may utilize any unassigned protocol value. In the presently preferred embodiments, unassigned protocol value “102” is chosen for the tracer packet protocol. In addition, the tracer packet protocol may be referred to as Heterogeneous Access Network Tracking (HANT) Protocol. The protocol value may be used to identify tracer packets within the datastream.

The HANT data 626 is not part of the standard Internet header format of an IP-packet. It should be recognized, however, that the HANT data 626 may be added to a standard IP-packet without modification of standard packet switching datastream transmission. Further, the variable length feature of the HANT data 626 avoids instability of the transport system within the communication system 100.

In one embodiment, the HANT data 626 of the tracer packet may be divided into eight-byte data segments. Each of the segments may be used to store access network information as the tracer packet travels through the heterogeneous access networks 110a-c. Each attribute collected and stored in the tracer packets may be represented by one of the segments. Attributes may include, for example, congestion levels, delay levels or any other attributes pertaining to operational characteristics of the communications system 100, and operational characteristics of the access networks 110a-c such as bandwidth and latency, or any other device(s) operating within the communication system 100.

The format of segments includes a node-type field 630, a node-id field 640, an attribute name field 650, an attribute value field 660, an attribute type field 670 and a timestamp field 680. The node-type field 630 may describe the type of devices operating as nodes or gateways. For example, the node-type field 630 may indicate a node is an access router. The node-id field 640 may provide a unique identifier assigned to nodes and gateways on which the communication system 100 is operating. For example, the node-id may identify a node as “ar3241.”

The attribute name field 650 may provide a description identifying the attribute included in the segment. For example, an attribute related to latency at an access network 110a-c may have an attribute name of “latency.” The attribute value field 660 may be a numerical value, characters or some combination thereof that are descriptive of the current state of the attribute. For example, the attribute value field 660 associated with the attribute “latency ” may include the term “high” or the number “30” in units of seconds to indicate the presence of a high latency. The attribute type field 670 may provide categories for grouping different attributes included in the network service information and the network condition information. The timestamp field 680 may include the time at which the attribute was stored in the tracer packet.

During operation, the access networks 110a-c may add segments to the tracer packet for each attribute. As segments are added, the value in the total length field 606 may be modified accordingly. Where a tracer packet passes through a node multiple times, new segments are added with each pass. In another embodiment, the node updates segments previously written to the tracer packets with the latest network service information.

The flexible packet length of the tracer packet provides for variable amounts of storage capability. As such, tracer packets may be utilized without regard to the number of nodes and gateways through which the tracer packets may travel. In addition, expansion of the communication system 100 to additional nodes and gateways may accommodate future growth.

In another embodiment, the HANT data 626 of the tracer packet may be one variable length data segment. In this embodiment, information stored in the tracer packet may be appended to information previously stored therein. The appended information may be encoded in, for example, extensible markup language (XML). As such, modification of the variable data segment as well as processing techniques may be performed, without modification to the tracer packet format.

Referring again to FIG. 4, the NMM 410 connects to the network interface module 130 that manages the available network interfaces NI1, NI2 and NI3. The NNM 410 determines a default network interface, such as interface NI1, to accommodate communications between the end device 120 and other devices. A server communication control 420 connects with the NMM 410 to communicate with at least one remote probing server 210a-c to receive probing commands. The server communication control 420 uses, for example, the default available network access service NI1 to communicate with the remote probing server 210a-c and/or the Hyper Operator server 140. The remote probing server 210a-c controls the components of the end device 120 through the server communication control 420.

A data cache 430 connects between the server communication control 420 and the NMM 410 and stores probing results information. The data cache 430 is accessible by the remote probing server 210a-c through the server communication control 420. The NMM 410 performs network probing when triggered, such as by the remote probing server 210a-c. The NMM 410 takes triggering information from a probe requester 440, which provides the probing trigger and information including which remote host and which network interface 110a-c to probe. For example, if a remote host for a LAN is to be searched, a LAN card on the end device 120 is activated and probes are sent to discover available LAN hosts. The available hosts are also probed for other information, such as bandwidth and latency. The probing results are saved into the data cache 430.

The probe requester 440 connects to probing requests from three possible sources. The first is an Auto Probe Triggering device 450, which is configured and controlled by the remote probing server 210a-c. When configured, the Auto Probe Triggering 450 periodically sends probing requests to the probe requester 440. The periodicity of the sent probes can vary. For example, if the subscriber has a contract requiring that a connection with the best available bandwidth always be provided, then probes may be sent more frequently. The second triggering component is the Event Based Triggering device 460, which is also controlled and configured by the remote server 210a-c. The Event Based Triggering 460 triggers a probe upon the occurrence of defined events. For example, a probe may be triggered when the end device 120 moves from one region to another, or when the actual bandwidth received by the end device 120 falls below a certain level. The third triggering component is the User Triggering 470, which is configured and controlled by the remote server 210a-c to give the user, e.g., the subscriber, options to trigger a probe. For example, the User Triggering 470 enables the subscriber to check availability of a better access network service at the subscriber's location and upon the subscriber's request.

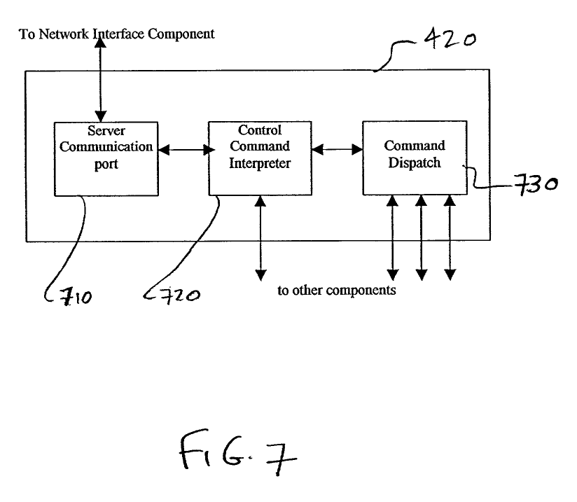

FIG. 7 shows an exemplary structure of the server communication control 420. The server communication control includes a server communication port 710 that sends and receives information to and from a remote server, such as the Hyper Operator server 140. The information is sent through the network interface, such as network interface NI1. A control command interpreter 720 parses messages from the Hyper Operator server 140 and if control command interpreter 720 recognizes the message, it will execute the control command from the Hyper Operator server 720. For example, a control command may reset a configuration parameter in another component such as the data cache 430. Regarding messages that the control command interpreter 720 does not recognize, the unrecognizable message is passed to another component, such as the command dispatch 730. The command dispatch 730 decodes the message and determines which component the message is destined to, then dispatches the message to that component.

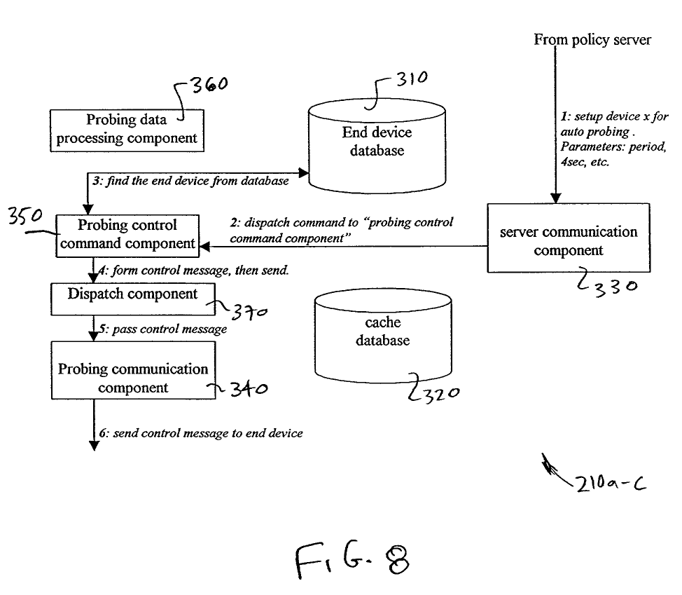

FIG. 8 illustrates the probing server 210a-c of FIG. 3 including an exemplary message sequence for scheduled probing. The described system can be used to enforce a subscriber service contract that offers agreed upon terms such as offering the subscriber the best possible access network service quality at any location, any time. For example, the Hyper Operator may provide different services to different class of subscribers. For premium subscribers, the Hyper Operator may need to determine the best, yet possibly most expensive, network service available at any locale and time, and switch the subscriber's end device 120 to use that network service. For economy subscribers, the Hyper Operator may need to determine the most economical service available instead. As another example, during a hyper handover, which is defined as a handoff between two access networks of different types, such as from a cellular network to a wireless LAN, the Hyper Operator may need to determine which is the best network connection among available networks.

The QoS information may involve a local wireless link error rate, transmission latency, or IP route efficiency to a remote correspondent node. Preferably, the Hyper Operator tracks the QoS information at each end device 120 dynamically without causing unreasonable traffic overhead, with tens of millions of subscribers and millions active simultaneously. The Hyper Operator determines available access network services when the user enters or leaves the coverage area of a better quality access network, such as a wireless LAN. For this purpose, the probing servers 210a-c can set the end device probing system (FIG. 4) into Scheduled probing mode, in which the access network availability and related QoS information are probed using the end device 120, for example, every few seconds.

On the probing server 210a-c, the components work together as illustrated in FIG. 8. The Hyper Operator server 140 sends a message to the server communication component 330 to setup device x, for example, the end device 120, for automatic probing. Other parameters are also sent, such as the time period between automatic probes, for example, four seconds between probes. The server communication component 330 receives the message and dispatches a command to the probing and control component 350. The probing control command component 350 determines information about the end device 120 from the end device database 310, such as how to communicate with the end device 120. The probing control command component 350 then forms and sends a control message to the dispatch component 370. The dispatch component 370 passes the control message to the probing communication component 340 which sends the control message to the end device 120.

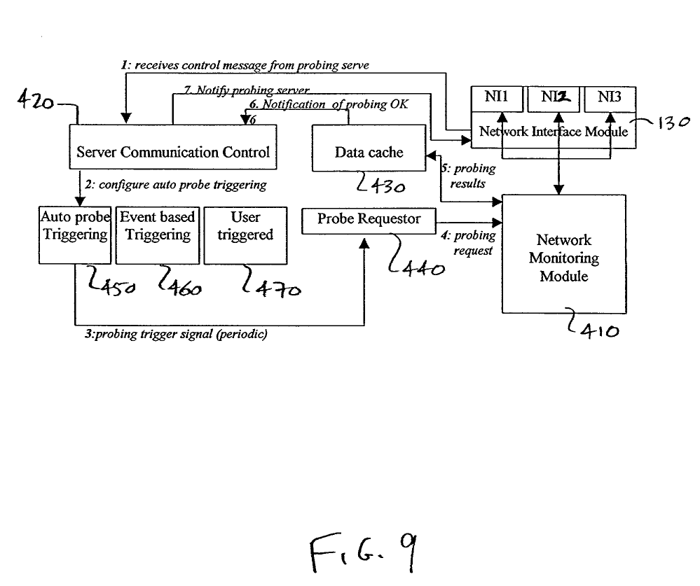

FIG. 9 illustrates how the probing component of the end device 120 receives the control message from the probing server 210a-c. The end device 120 receives the control message at the server communication control 420 via the network interface module 130. Typically, a default interface, such as interface NI1 is used to send the control message. Other interfaces could be used, however, such as NI2 or NI3. Information regarding how to access the interfaces NI1 can be stored in the end device database 310 at the probing server 210a-c (FIGS. 3 and 8). The server communication control 420 configures the end device for automatic probe triggering via the Auto Probe Triggering component 450.

To initiate automatic probing, the Auto Probe Triggering component 450 sends a probing trigger signal every so often, for example, as dictated by the parameters sent by Hyper Operator server 140. The signal can be sent periodically, for example, every few seconds, or non-periodically, fro example based on a formula. The Probe Requestor 440 sends a probing request to the NMM 410 upon receiving the probing trigger signal from the Auto Probe Triggering component 450. The NMM 410 sends out a tracer packet to determine which access networks 210a-c are available to the end device 120. At the end of a probe, the end device 120 sends a notification to the probing server 210a-c about probing results. The probing server 210a-c determines when to send control commands to the end device 120 to request a transfer of data.

In another embodiment, the system is used for real time probing of available access networks 210a-c. At a given situation for a certain customer, the Hyper Operator decides the currently available access network services at the subscriber's end device 120. For this purpose, the Hyper Operator's server 140 sends a request to probing server 210a-c, which sends a control command to the end device probing component 200 (FIG. 2) for an immediate network probe. The sequence of messaging at the probing server 210a-c is depicted and described above with regard to FIG. 8.

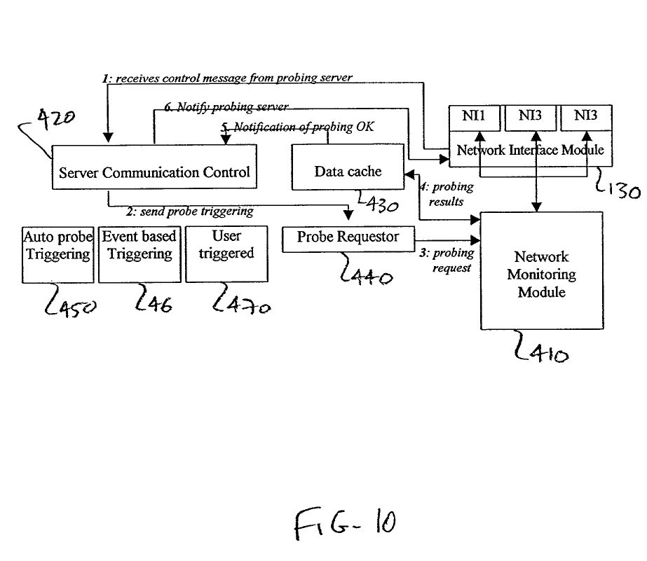

FIG. 10 is a block diagram illustrating the probing component of the end device 120 including an exemplary message sequence showing real-time probing. The end device 120 receives a control command from the probing server 210a-c. The server communication control 420 sends a probe triggering message to the Probe Requestor 440. The Probe Requestor 440 sends a probing request to the NMM 410. The NMM 410 uses tracer packets to probe the access networks 110a-c. The probing results are then received by the NMM 410 which sends the results to the data cache 430. The data cache 430 sends a notification to the server communication control 420 that the probing was successful. Thereafter, the server communication control 420 notifies the probing server 210a-c that the probing results have been received. The probing server 210a-c can then send a command to the end device 120 to send the results to the probing server 210a-c or the probing server can read the results directly from the end device 120.

While the invention has been described above by reference to various embodiments, it will be understood that many changes and modifications can be made without departing from the scope of the invention. It is therefore intended that the foregoing detailed description be understood as an illustration of the presently preferred embodiments of the invention, and not as a definition of the invention. It is only the following claims, including all equivalents, which are intended to define the scope of this invention.

We claim:

1. A method for an operator to monitor access network services available to an end device, where the end device communicates in a heterogeneous network environment, the method comprising:
a) instructing the end device to determine available access networks located with the heterogeneous network environment;
b) collecting access network information from at least one node within the heterogeneous network; and
c) making the access network information available to the operator.

2. The method of claim 1, further including:
d) providing the access network to the end device in accordance with the collected information.

3. The method of claim 1, wherein b) comprises generating a probe.

4. The method of claim 3 wherein the probe comprises a tracer packet.

5. The method of claim 4 wherein the tracer packet includes a format substantially similar to an application data Internet protocol (IP) packet with the addition of heterogeneous access network tracking (HANT) data.

6. The method of claim 3 wherein the probe is initiated automatically.

7. The method of claim 6 wherein the probe occurs periodically.

8. The method of claim 3 wherein the probe is initiated upon the occurrence of an event.

9. The method of claim 8 wherein the event comprises a bandwidth of the end device being below a determined level.

10. The method of claim 3 wherein the probe is initiated by a user of the end device.

11. The method of claim 3, wherein b) comprises:
extracting the probe from the datastream;
storing access network information in the probe; and
returning the probe to the datastream.

12. The method of claim 1, wherein a Hyper Operator provides the access network to the end device.

13. The method of claim 12 wherein the Hyper Operator determines available access networks from the collected information.

14. The method of claim 1 further including a probing server, wherein the probing server sends instructions to the end device to control probing.

15. A network system for an operator to monitor access network services available to an end device, where the end device communicates in a heterogeneous network environment, the system comprising:
a probing server to instruct the end device to determine available access networks located with the heterogeneous network environment;
a probe sent by the end device upon instruction from the probing server, wherein the probe collects access network information from at least one node within the heterogeneous network; and
a database to store the access network information.

16. The system of claim 15 wherein the access network is provided to the end device in accordance with the collected information.

17. The system of claim 15 wherein the probe comprises a tracer packet.

18. The system of claim 17 wherein the tracer packet includes a format substantially similar to an application data Internet protocol (IP) packet with the addition of heterogeneous access network tracking (HANT) data.

19. The system of claim 15 wherein the probe is initiated automatically.

20. The system of claim 19 wherein the probe occurs periodically.

21. The system of claim 15 wherein the probe is initiated upon the occurrence of an event.

22. The system of claim 21 wherein the event comprises a bandwidth of the end device being below a determined level.

23. The system of claim 15 wherein the probe is initiated by a user of the end device.

24. The system of claim 15 wherein the probe is extracted from the datastream, access network information is stored in the probe, and then the probe is returned to the datastream.

25. The system of claim 15 further including a Hyper Operator to provide the access network to the end device.

26. The system of claim 25 wherein the Hyper Operator determines available access networks from the collected information.

27. The system of claim 15 wherein the probing server sends instructions to the end device to control probing.
